(19) United States
(12) Patent Application Publication
(10) Pub. No.: US 2003/0137146 A1
(43) Pub. Date: Jul. 24, 2003

(54) Address credit card

(76) Inventor: Keith Anthony Washington, Oakland, CA (US)

Correspondence Address: Keith Anthony Washington, 2101 10th Ave, Oakland, CA, 94606, US

(21) Appl. No.: 10/246,187

(22) Filed: Sep. 17, 2002

Related U.S. Application Data
(60) Provisional application No. 60/350,583, filed on Jan. 24, 2002.

(51) Int. Cl. G09C 3/00; B42D 15/00

(52) U.S. Cl. 283/75

(57) ABSTRACT

A thin flat plastic card, which is colored in the form of a rectangular configured card. With front and back surfaces, made of a flexible material so that it can be bent. An anti-fraud credit card that is of the utmost simplicity, ease of use and minimum cost to make. A card that uses ones telephone number and address as its numbers, to prevent misuse of the credit card.

### BACKGROUND—FIELD OF INVENTION

This invention relates to a thin flat plastic card, a anti-fraud credit card that uses one's phone number and mailing address as its numbers.

### OBJECTS AND ADVANTAGES

Accordingly, several objects and advantages of the present invention are:

(a) A credit card that can be kept in plain view, without worry of it being stolen.

(b) A credit card that will allow merchants to safely ship thousands of dollars in merchandise with confidence.

(c) A credit card merchants will not have any fraudulent charge backs with.

(d) A credit card that is unique and fraud proof because of its use of its numbers.

(e) A credit card that has numbers that cannot be stolen.

(f) A credit card that will make people feel good and safe, about shopping at home.

(g) A credit card that will be 100 percent fraud proof.

(h) A credit card that protects the bank, the customer, and the merchant.

### DESCRIPTION

A credit card that is of the utmost simplicity, ease of use and minimum cost; while at the same time being highly effective in preventing misuse of the credit card. This card has a built-in security feature, when this card is used on-line or on the telephone, the merchant will know right away if it is someone trying to commit fraud. The numbers on this card are what makes this card unique and fraud proof. If the first digits on the card are 2101, after I give the complete card number, and the merchant asks me for my mailing address. I then tell him or her that my address is: 2101 10th avenue. They will then match the first numbers of my address. If I told them, for instance, my address was 1101 104th avenue, they would immediately know that this was a fraudulent activity. You can only have packages sent to the address the card has been issued to.

If a person lives in a multi-unit apartment building, it will work the same. If a person's address is: 1568 oakdale drive apartment #16: the first 6 digits will look like this 156816. If a person lives in a building with letters only, let's say the letter E is on the door. The card number would look like this 15685. The fifth number would be a five for the fifth letter of the alphabet. If a person is buying a product with a mail order form. When it is received by the merchant he or she can clearly see and determine if it is a fraudulent activity. My address and credit card numbers will be exactly the same.

Banks will also have the option of using the last four digits, as a valued customer date. This date will show the merchant how long a person has done business with a particular bank. Another option banks can use will be combining the last four digits of a persons phone number with the card number. This will stop credit card fraud against non-tanible purchases. Such as newspaper ads and internet services. The merchant can use caller ID or, they can choose to return a person's call. If the last four digits of the person's phone number doesn't match the card number, once again, the merchant will know it is a fraudulent activity.

### SUMMARY

A credit card that is of the utmost simplicity, ease of use and mimimum cost to make, while at the same time being highly effective in preventing misuse of the credit card. The numbers on the credit card are a built in security feature. When this card is used on-line or on the telephone, or in the mail, the merchant will know right away if it is someone trying to commit fraud. This credit card uses a person's telephone number and address as its numbers.

I claim:

1. A thin flat card, that uses a person's telephone number and mailing address as its numbers.
